(19) United States
(12) Patent Application Publication
(10) Pub. No.: US 2025/0180189 A1
(43) Pub. Date: Jun. 5, 2025

(54) FIRE-RATED DOWNLIGHT HOUSING

(71) Applicant: Rayon Lighting Group, Inc., Compton, CA (US)

(72) Inventors: Isaac Ferey, Los Angeles, CA (US); David Ferey, Encino, CA (US)

(73) Assignee: Rayon Lighting Group, Inc., Compton, CA (US)

(21) Appl. No.: 18/964,212

(22) Filed: Nov. 29, 2024

Related U.S. Application Data
(60) Provisional application No. 63/604,606, filed on Nov. 30, 2023.

(51) Int. Cl. F21V 15/01; F21S 8/02; F21V 23/02; F21Y 115/10

(52) U.S. Cl. CPC F21V 15/01; F21S 8/026; F21V 23/02; F21Y 2115/10

(57) ABSTRACT

A fire-rated downlight fixture is constructed so that the entirety of the inner and outer housing walls and compartments are all fabricated from materials which provide a 2-hour fire rating and compliance with applicable building fire codes, such as UL263 and/or UL514A. The downlight fixture has a housing having a top wall, opposing side walls, opposing end walls, and a bottom wall with a downlight opening. An interior dividing wall extends between the opposing side walls creating a larger main compartment at one end of the housing for receiving a lighting module and a smaller junction box compartment at the opposing second end of the housing and wherein the interior dividing wall has an access opening therein. The downlight fixture may have a removable trim collar received with the downlight opening.

### CROSS-REFERENCE TO RELATED APPLICATIONS

This application is a non-provisional application of, and claims the benefit of U.S. Provisional Patent Application No. 63/604,606, filed Nov. 30, 2024, the entire contents of which are incorporated herein by reference.

### BACKGROUND OF THE DISCLOSURE

(1) Field of the Invention: The instant disclosure generally relates to fire-rated electrical housings and junction boxes and more particularly fire-rated lighting fixtures.

### (2) DESCRIPTION OF RELATED ART

Each year state and national fire codes become more restrictive for various electronic components, housings and fixtures in order to improve safety in both new and old construction.

Prior art downlight fixtures (recessed light fixtures) for incandescent bulbs (as well as LED modules) comprised a thin sheet metal housing or “can” which enclosed the LED module/bulb and reflector elements and an external junction box or J-Box where the 120V electrical feed wiring entered the fixture and connected to the fixture receptacle. Early versions of the downlight sheet metal housings were neither air tight nor fire rated and were in most cases in direct contact with insulation or other building materials within the ceiling structure. Heat generated from the lighting elements readily traveled through the fixtures to the surrounding insulation and building materials. Additionally, in the event of a fire, the fixtures did not provide an adequate fire block between the ceiling and the floor above.

Attempts have been made to adapt old fixture designs to the new fire and code ratings, such as providing bigger housings and/or providing insulation within the housing interior, or providing external, insulated fire-rated enclosures which are fitted over the top of the entire downlight fixture. In this regard, the noted insulation and domed insulated enclosures help these older designs meet a UL263 fire rating which is applicable to such housings. While effective to meet code, these insulated fixtures and structures are obviously very large, and in some cases, not practical for many installation scenarios. In particular, older fire rated housings will not fit into available space because of shallow plenum dimensions and plenum space in new buildings is becoming more and more shallow with time.

With the transition to LED lighting, the continual increase in power and heat generated from LED lighting modules, and the stricter building and fire code requirements, downlight fixtures and housings need to quickly adapt to meet industry needs. With respect to newer (smaller) LED lighting modules, some prior art configurations have adapted junction boxes (J-boxes) to provide mounting options to directly receive the lighting modules within the J-box. J-boxes are subject to UL514a fire-ratings and as such a UL514A type junction box can directly provide a needed fire-rating to some types of LED modules which can fit within a J-box type fixture.

However, larger LED modules and modules with adjustable angle brackets cannot directly fit within the smaller J-box configurations.

### SUMMARY OF THE DISCLOSURE

Accordingly, there is a need in the industry to provide an improved downlight fixture and housing that meets current fire ratings and safety codes, that is compact in size to accommodate virtually any installation type and space (small or big) (wet or dry) (new construction or old retrofit), and that provide adaptability in terms of lighting components, driver modules, angular adjustments, trim packages, emergency battery backup power supplies, and feed wiring for both standard 120-277V and low voltage connections.

According to exemplary embodiments of the invention, a “fire-rated” downlight fixture in accordance with the present invention is constructed so that the entire inner and outer housing walls and compartments are fabricated from materials which may provide the same fire-rating as applied to either housings (UL263) and/or J-Boxes (UL514A). For example, a typical UL514A rated junction box is constructed from at least 16GA cold-rolled steel sheet metal to provide a 2-hour fire rating.

In an exemplary embodiment, the present fixture housing is constructed entirely from 16GA cold-rolled steel sheet metal in a generally rectangular configuration with a downlight opening in the lower surface thereof. 3-inch, 4-inch, 5-inch and 6-inch downlight openings, as well as smaller 1-inch and 2-inch openings, are contemplated. The housing may be about 7 inches wide, 6 inches long and 4 inches tall, making it an ideal size for virtually any installation scenario. Opposing side walls are fitted with vertically sliding hanger clamps for receiving longitudinally adjustable (telescoping) hanger bars to accommodate unknown and varying ceiling thicknesses as wall as unknown joist spacing.

The housing includes an internal dividing wall which creates a main LED module compartment and a smaller junction box (j-box) compartment at one of the ends of the housing. A junction end panel is removably secured to the same end of the housing to provide exterior access into the junction compartment. The junction box compartment provides spacing for feed wire connections and the LED driver module outside of the main LED module compartment. The housing includes a plurality of wiring knockouts positioned at the junction box compartment which are capable of receiving wire conductors IC rated for contact with insulation. This end of the housing functions as the de facto junction box of the housing, but is integrally constructed and internalized as part of the housing itself.

Within the dividing wall is an access opening which receives a removable access panel having hinge tabs at a lower end thereof and a spring retention tab at an upper end thereof. A LED driver module is mounted to the outwardly facing side of the access panel so that it is located within the junction compartment when mounted in place. The removable access panel is pivotably removable from the dividing wall from within the interior of housing (through the downlight opening) (ceiling accessible) where it can provide access to changing or replacing the electronics module after installation. 120-277V feed wiring is joined to the electronic driver module inputs within the junction compartment and the lower voltage module feed wires pass through a grommet hole at the top edge of the dividing wall into the main compartment. The module feed wiring and the LED module may include suitable releasable mating connectors for easy installation and removal.

On the opposing end of the housing is another removable end panel which can optionally be replaced by an emergency backup battery module which can provide for a minimum of 90 minutes of battery power with automatic switchover integral to the fixture. In an exemplary embodiment, a 4-watt battery unit provides enough lumens to comply with NFPA 101 safety code. The battery backup module includes a flanged backbox housing securable to the end of the housing and a battery wall access panel which is also removable inwardly from within the interior of the main cavity. The end panel is removed, and a backbox housing is added in order to fit the battery backup module. This backbox housing may be constructed from the same 16GA cold rolled steel material to meet the required UL263 and/or UL514A fire rating. The battery module unit is thus removable from within the housing through the ceiling, unlike other fire rated housings.

A dedicated low voltage wire conduit is located on an upper inside corner of the housing and extends along the length of the main compartment from the battery backup module end of the housing to the junction box dividing wall. The wire conduit provides a passage for the low-voltage battery lead wires to extend from the battery module into the junction compartment. The wire conduit is constructed as an integral part of the housing, and formed from the same 16GA cold rolled steel materials to meet the required UL263 and/or UL514A fire rating.

The housing accepts downlight, wall wash, and adjustable modules and is suitable in residential and commercial applications and may be utilized where fire rating is required.

A removable trim collar is secured to the bottom of the housing and may be provided in an assortment of shapes, sizes and finishes in both flanged and flangeless versions. Flanged trim may be compatible with all ceiling materials.

While embodiments of the invention have been described as having the features recited, it is understood that various combinations of such features are also encompassed by particular embodiments of the invention and that the scope of the invention is limited by the claims and not the description.

### BRIEF DESCRIPTION OF THE DRAWINGS

While the specification concludes with claims particularly pointing out and distinctly claiming particular embodiments of the instant invention, various embodiments of the invention can be more readily understood and appreciated from the following descriptions of various embodiments of the invention when read in conjunction with the accompanying drawings in which:

FIG. 1 is a perspective view of a downlight fixture constructed in accordance with the teachings of the present invention;

FIG. 2 is an exploded view thereof with the LED lighting module and trim removed from the trim collar;

FIG. 3 is a side view of the downlight housing;

FIG. 4 is a bottom view of the downlight housing with the hanger bars removed.

FIG. 5 is an exploded perspective view of the downlight housing;

FIG. 6 is a top view thereof;

FIG. 7 is a cross-sectional view of the downlight housing taken along line 7-7 of FIG. 6;

FIG. 8 is a cross-sectional view of the downlight housing taken along line 8-8 of FIG. 6;

FIG. 9 is a bottom perspective view of the downlight housing with the bottom wall removed;

FIG. 10 is perspective view of an alternative embodiment of the downlight fixture including a battery backup housing module constructed in accordance with the teachings of the present invention;

FIG. 11 is a top view thereof; and

FIG. 12 is a perspective view of the battery housing and batter access panel.

### DETAILED DESCRIPTION OF THE EXEMPLARY EMBODIMENTS

Certain exemplary embodiments will now be described to provide an overall understanding of the principles of the structure, function, manufacture, and use of the device and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present disclosure. Further, in the present disclosure, like-numbered components of the embodiments generally have similar features, and thus within a particular embodiment each feature of each like-numbered component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Further, to the extent that directional terms like top, bottom, up, or down are used, they are not intended to limit the systems, devices, and methods disclosed herein. A person skilled in the art will recognize that these terms are merely relative to the system and device being discussed and are not universal.

According to exemplary embodiments of the invention, and referring now to the drawing figures, a fire-rated downlight fixture housing in accordance with the present invention is constructed so that the entirety of the inner and outer housing walls and compartments access panels are fabricated from materials which may have the same 2-hour fire-ratings as applied to insulated housings and junction boxes, i.e. UL263 and/or UL514A.

The present downlight fixture housing is generally indicated at 10 and in an exemplary embodiment, may be constructed from 16GA cold-rolled steel sheet metal in a generally elongated rectangular configuration. While a generally rectangular configuration is illustrated in the drawing figures, the term generally elongated may be interpreted to include any elongated housing structure including top, bottom, opposing sides and end walls as may be suitable and appropriate to enclose a respective lighting module. Such shapes may include rounded or chamfered corners, other generally quadrilateral shapes, or other shapes, such as hexagonal and octagonal shapes, and elongated hexagonal and octagonal shapes, having an even number of sides with opposing side walls and end walls. Additionally, while rolled steel sheet metal is indicated as an exemplary material, other metal and/or composite materials are available which may also provide the same fire rating, and should be considered as within the scope of the disclosure.

The generally rectangular housing 10 may be about 7 inches wide, 6 inches long and 4 inches tall, making it an ideal size for virtually any installation scenario. In comparison, the prior art housing fixtures are typically larger in size, measuring roughly 8 inches wide, 11-12 inches longer and 6-7 inches tall. Prior art fire-rated housings use a larger housing and are limited up to approximately 1000 lumens. The present fire-rated housing is much smaller and may accept lighting modules up to 1600 lumens.

The downlight fixture housing 10 generally has an elongated rectangular configuration including a top wall 12, opposing side walls 14, 16, and a bottom wall 18 with a downlight opening 20.

An interior dividing wall 22 extends between the opposing side walls 14, 16 creating a larger main compartment 24 at one end of the housing for receiving a lighting module 26, and a smaller junction box compartment 28 at the opposing second end of the housing. The interior dividing wall 22 has an access opening 30 therein, and an access panel 32 is removably securable within the access opening 30 from within the main compartment.

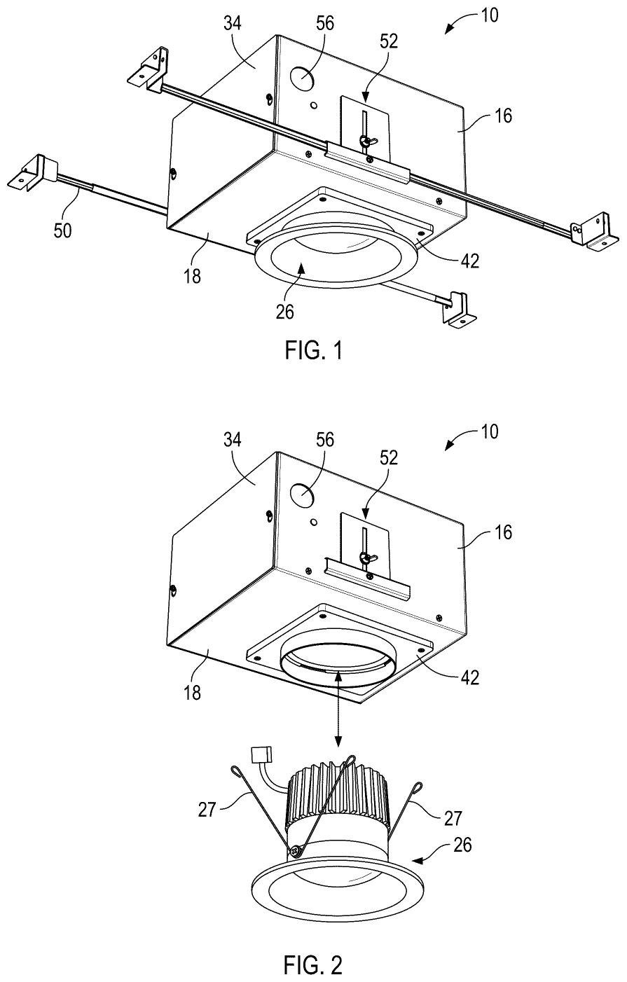

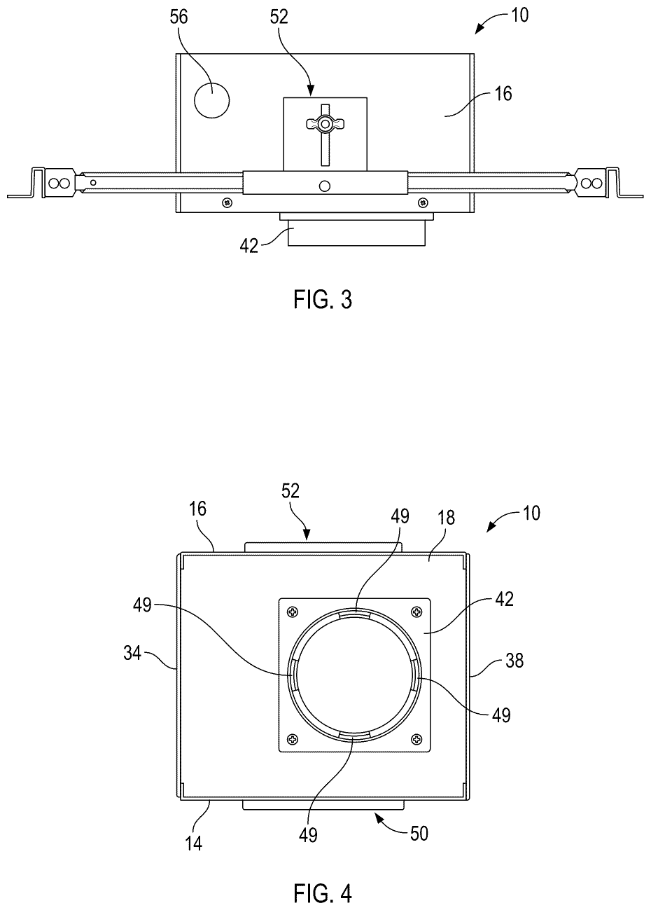

The present disclosure discusses and identifies LED lighting modules 26 (generally illustrated in FIG. 2). However, it is to be understood that the teachings and concepts herein disclosed with respect to the downlight housing are equally applicable to any lighting module technology, and neither the disclosure nor the claims should be limited by this exemplary teaching, except where particularly called out in certain claims.

The housing 10 further comprises a first removable end panel 34 at a junction box compartment 28 end of the housing (secured with fasteners 36) and a second removable end panel 38 at the main compartment end 24 of the housing (secured with fasteners 40).

A removable trim collar 42 may be received within the downlight opening 20 to accommodate various lighting modules and trims. 3-inch, 4-inch, 5-inch and 6-inch trim collar openings, as well as smaller 1-inch and 2-inch openings, are contemplated. The trim collar 42 may be adapted to accept wall wash or adjustable angle adapters as part of the lighting module 26 and may in turn may interchangeably receive a variety of conventional lighting and/or LED module packages. Round, square or other suitably-shaped collars may be provided to accommodate similarly shaped lighting trims.

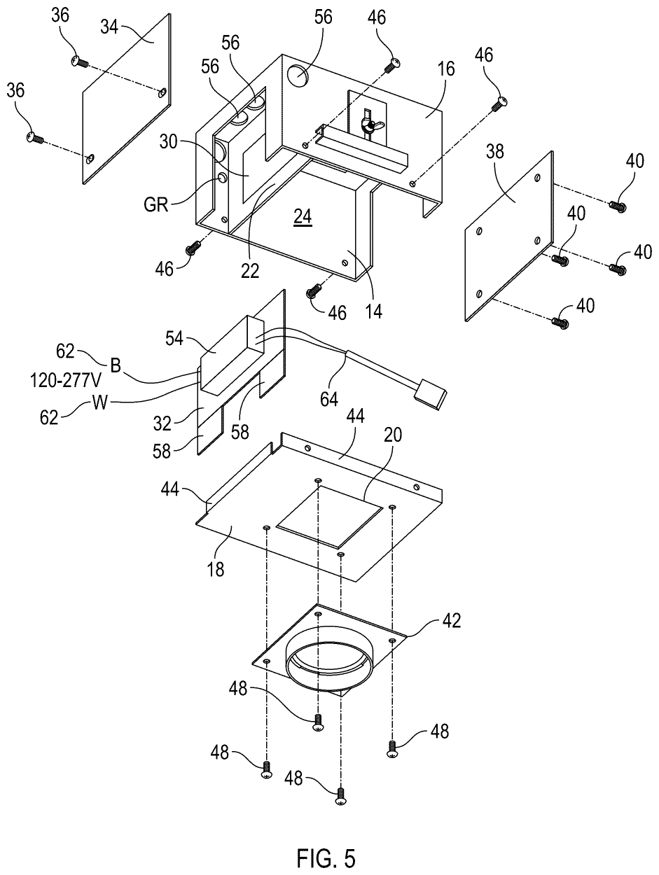

Referring briefly to FIG. 5, in an exemplary configuration, the top wall 12 and opposing side walls 14, 16 may be formed in a U-shaped configuration and the bottom wall 18 includes upward turned securing flanges 44 removably secured to the terminal edges of the opposing side walls 14, 16 with fasteners 46. The end wall panels 34, 38 are removably secured to inward turned terminal lip edges of the top wall 12 and opposing side walls 14, 16 with fasteners 36, 40 as previously described. The trim collar 42 may be removably received over/within the downlight opening 20 by means of fasteners 48 extending through the trim collar flange and into threaded openings on an external surface of the bottom wall. The trim collar 42 may include a plurality of opposing hanger slots 49 for receiving spring wire hangers 27 which extend from the light module 26 as is common in the art.

As noted above, the entirety of all the housing walls, access panels and compartment features are constructed from materials which provide a 2-hour fire rating and compliance with building fire codes applicable to electrical housings and electrical junction boxes. As noted above, the exemplary embodiments utilize 16GA steel sheet metal.

The downlight housing 10 further comprises first and second vertically adjustable and telescoping hanger bar assemblies 50, 52 disposed on the opposing side walls of the housing.

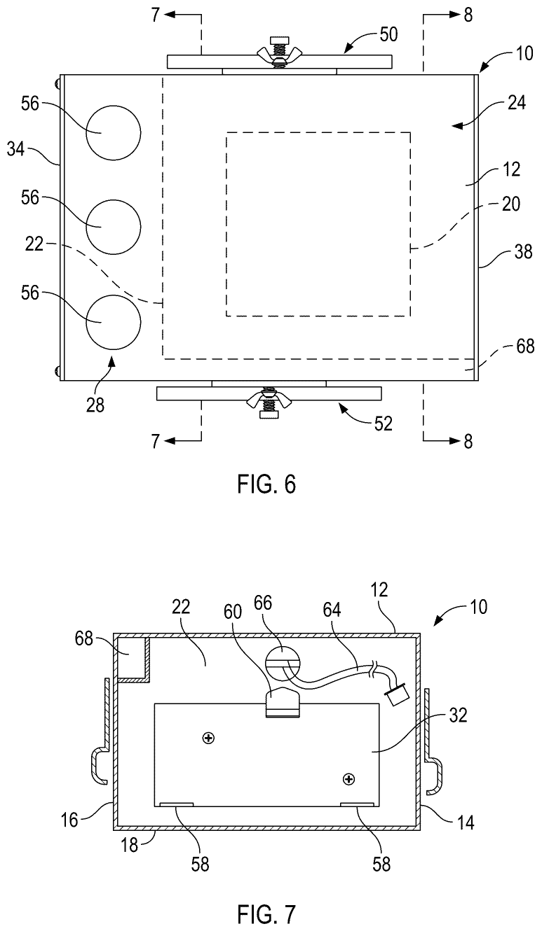

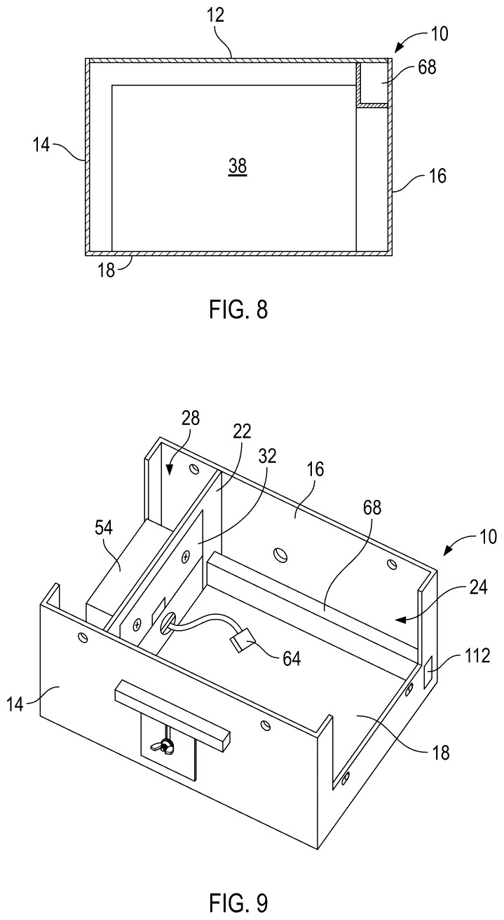

As best seen in FIGS. 5-9, the internal dividing wall 22 of the housing creates the main LED lighting module compartment 26 and the smaller junction box compartment 28 at the opposing ends of the housing. The junction end panel 34 is removably secured to the junction box end of the housing to provide exterior access into the junction compartment 28 during installation. The junction box compartment 28 provides space for feed wire connections and wire nuts (not shown), and for an LED driver module 54 to sit outside of the main LED module compartment 24. The housing 10 may include a plurality of standard wiring knockouts 56 (may be of varying sizes) located in the walls of the junction box compartment 28. In the illustrated embodiment, the opposing side walls each include a single knockout 56 adjacent to the top wall, while the top wall includes three (3) knockouts 56 spaced along the end edge for communication into the junction box compartment. The knockouts 56 are capable of receiving wire conductors which are IC rated for contact with insulation. This end of the housing functions as the de facto junction box of the housing, but it is integrally constructed and defined within the housing itself. By integrating the junction box space within the housing and forming the entire housing 10 of materials equivalent to a junction box, the entire housing fixture can achieve a suitable UL fire-rating for most construction scenarios.

Referring to FIGS. 5, 7 and 9, the dividing wall 22 includes access opening 30 which receives a removable access panel 32 having hinge tabs 58 at a lower end thereof and a spring retention tab 60 at an upper end thereof. For LED lighting fixtures, an LED driver module 54 is mounted to the outwardly facing side of the panel 32 so that it is located within the junction compartment 28 when mounted in place. The removable access panel 32 is pivotably removable from the dividing wall 22 from within the interior of housing (through the trim collar 42 and downlight opening 20) (ceiling accessible) where it provides the ability to change and/or replace the driver module 54 after installation. 120V feed wiring (not shown) may be joined to the electronic driver module inputs 62 within the junction box compartment 28 while the lower voltage module feed wires 64 pass through a grommet hole 66 at the top edge of the dividing wall 22 into the main compartment. The module feed wiring, low voltage wiring and the LED module wiring may include suitable crimped and/or releasable mating connectors for installation and removal.

The housing 10 further includes a low-voltage wire conduit 68 extending between the interior dividing wall 22 and a terminal lip wall of the main compartment, creating a dedicated wiring path for low voltage wiring from the junction box compartment 28 to the terminal lip wall of the main compartment. The wire conduit 68 may be utilized for auxiliary power sources such as a battery backup (to be described hereinafter), and like the other structural features of the housing, the conduit 38 is constructed from a material which provides a 2-hour fire rating and compliance with building fire codes applicable to electrical junction boxes.

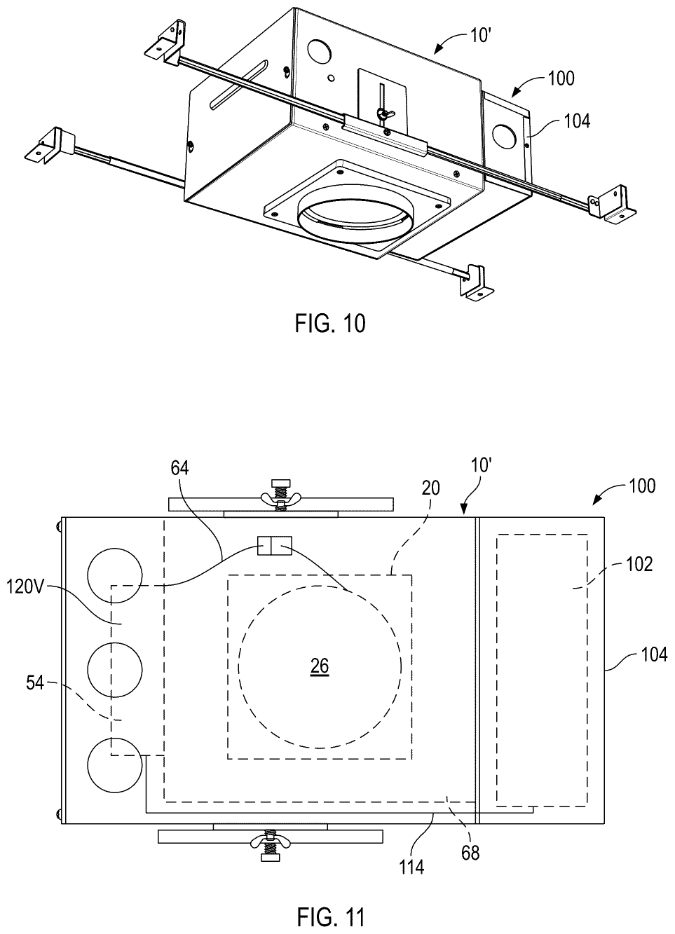

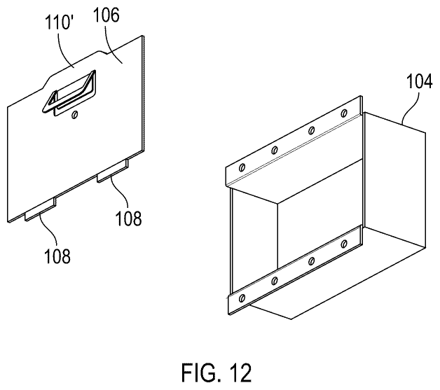

Referring now to FIGS. 10-12, an alternative embodiment is illustrated and generally indicated at 10′. All elements and features of the downlight housing 10′ are the same, with the exception of an optional emergency backup battery module 100 which can provide for a minimum of 90 minutes of battery power with automatic switchover integral to the fixture. In an exemplary embodiment, a 4-watt battery unit 102 provides enough lumens to comply with NFPA 101 safety code.

In this alternate configuration 10′, the second end panel 38 is removed. The battery backup module 100 includes a flanged open-ended backbox housing 104 securable to the end of the housing 10′ and a battery wall access panel 106 which is also removable inwardly from within the interior of the main compartment 24. The battery access panel 106 has pivot hinge tabs 108 and a spring tab 110 similar to the junction box access panel. The flanged backbox housing 104 and battery access panel 106 are made of the same material as the main housing 10/10′ with the intention of meeting applicable fire ratings.

To remove or replace the battery 102, a technician would remove the lighting module and trim 26, and pivot the battery wall access panel 106 inwardly to reveal the battery 102 within the battery housing compartment. The battery wall access panel 106 may be removed through the trim collar 42 to the outside, or it may remain in the main compartment. The technician will then have access to the wiring of the battery 102 and be able to take out the battery and associated components out through the trim collar 42. The battery housing 104 stays intact and in place within the ceiling.

As described above, the dedicated low voltage wire conduit 68 is located in an upper side interior corner of the housing 10′ and extends along the length of the main module compartment 22 from the battery module end of the housing to the dividing wall 22. An opening 112 from the battery end can be seen on the end wall in FIG. 9. The wire conduit 68 provides a passage for the battery lead wires 114 to extend from the battery module 102 into the junction box compartment 28 through the dividing wall 22 (see FIG. 11). Because the wire conduit 68 is integrally part of the housing 10′, and formed from the same materials as the housing, the same fire ratings would still be applicable.

Accordingly, it can be seen that the present disclosure provides a downlight fixture and housing which is uniquely versatile in its ability to accept downlight, wall wash, and adjustable angle lighting modules and which is suitable in both residential and commercial applications and may, in particular, be utilized where fire rating is required. The downlight fixture is Chicago Plenum rated is IC Airtight rated.

Accordingly, among to objectives of the invention are the following:

The provision of a downlight fixture comprising a generally elongated housing having, a top wall, opposing side walls, a bottom wall with a downlight opening, and an interior dividing wall extending between the opposing side walls creating a larger main compartment at one end of the housing for receiving a lighting module and a smaller junction box compartment at the opposing second end of the housing and wherein the interior dividing wall has an access opening therein, and wherein the entirety of the housing is constructed from a material which provides a 2-hour fire rating and compliance with building fire code ratings.

The provision of such a downlight fixture which further has an access panel removably securable with the junction box access opening from within the main compartment, a first removable end panel at the junction compartment end of the housing, a second removable end panel at the main compartment end of the housing.

The provision of a fire-rated downlight fixture having a removable trim collar received with the downlight opening.

The provision of a downlight fixture further including a low-voltage wire conduit extending between the interior dividing wall and a terminal lip wall of the main compartment, creating a dedicated wiring path for low voltage wiring from the junction box compartment to the terminal lip wall of the main compartment, said wire conduit being constructed from a material which provides a 2-hour fire rating and compliance with building fire code ratings.

The provision of a downlight fixture further comprising an LED lighting fixture receivable through the downlight opening and disposed within the main compartment, and an LED driver module removably secured to an exterior side of the dividing wall access panel so as to reside within the junction box compartment when the dividing wall access panel is secured in position.

The provision of a downlight fixture further comprising a backup battery module comprising, a battery module housing secured to the housing in place of the main compartment end panel, a backup battery receivable within the battery module housing and a battery wall access panel which is removably securable with the battery module housing from within the main compartment, wherein the battery module housing and battery wall access panel are constructed from a material which provides a 2-hour fire rating and compliance with building fire code ratings.

The provision of a downlight fixture wherein material providing a UL263 and/or UL514A fire rating is a cold rolled steel sheet metal of at least 16GA thickness.

The provision of a downlight fixture wherein the fixture has a UL263 and/or UL514A junction box fire rating.

The provision of a downlight fixture which is Chicago Plenum rated.

The provision of a downlight fixture which is IC Airtight rated.

The provision of a downlight fixture wherein the side and top housing walls include at least one knockout in communication with the junction box compartment.

The downlight fixture of claim 1 wherein the top wall and opposing side walls are formed in a U-shaped configuration, the bottom wall includes upward turned securing tabs removable secured to the terminal edges of the opposing side walls and the end wall panels are removably secured to inward turned terminal lip edges of the top wall and opposing side walls.

The provision of a downlight fixture wherein the removable trim collar is removably received within the downlight opening on an external surface of the bottom wall.

The provision of a downlight fixture further comprising first and second telescoping and vertically adjustable hanger bar assemblies disposed on opposing sides of the housing.

While there is shown and described herein certain specific structures embodying various embodiments of the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A downlight fixture comprising:
a housing comprising,
a top wall,
opposing side walls,
a bottom wall with a downlight opening;
an interior dividing wall extending between the opposing side walls creating a larger main compartment at one end of the housing for receiving a lighting module and a smaller junction box compartment at the opposing second end of the housing,
said interior dividing wall having an access opening therein;
an access panel which is removably securable with the access opening from within the main compartment;
a first removable end panel at the junction compartment end of the housing; and
a second removable end panel at the main compartment end of the housing;
wherein the entirety of the housing is constructed from a material which provides a 2-hour fire rating and compliance with applicable building fire codes.

2. The downlight fixture of claim 1 further comprising a removable trim collar received with the downlight opening.

3. The downlight fixture of claim 1 wherein the housing further includes an integrated wire conduit extending between the interior dividing wall and a terminal lip wall of the main compartment, creating a dedicated wiring path from the junction box compartment to the terminal lip wall of the main compartment,
said wire conduit being constructed from a material which provides a 2-hour fire rating and compliance with applicable building fire codes.

4. The downlight fixture of claim 1 further comprising:
an LED lighting fixture receivable through the downlight opening and disposed within the main compartment; and
an LED driver module removably secured to an exterior side of the dividing wall access panel so as to reside within the junction box compartment when the dividing wall access panel is secured in position.

5. The downlight fixture of claim 4, further comprising:
a backup battery module comprising,
a battery module housing secured to the housing in place of the main compartment end panel
a backup battery receivable within the battery module housing;
a battery wall access panel which is removably securable with the battery module housing from within the main compartment,
wherein the battery module housing and battery wall access panel are constructed from a material which provides a 2-hour fire rating and compliance with applicable building fire codes.

6. The downlight fixture of claim 1 wherein said material is a cold rolled steel sheet metal of at least 16GA thickness.

7. The downlight fixture of claim 1 wherein said downlight fixture has a UL263 and/or a UL514A fire rating.

8. The downlight fixture of claim 1 wherein the side and top housing walls include at least one knockout in communication with the junction box compartment.

9. The downlight fixture of claim 1 wherein the top wall and opposing side walls are formed in a U-shaped configuration, the bottom wall includes upward turned securing tabs removable secured to the terminal edges of the opposing side walls and the end wall panels are removably secured to inward turned terminal lip edges of the top wall and opposing side walls.

10. The downlight fixture of claim 9 wherein the removable trim collar is removably received with the downlight opening on an external surface of the bottom wall.

11. The downlight fixture of claim 2 wherein the top wall and opposing side walls are formed in a U-shaped configuration, the bottom wall includes upward turned securing tabs removable secured to the terminal edges of the opposing side walls and the end wall panels are removably secured to inward turned terminal lip edges of the top wall and opposing side walls.

12. The downlight fixture of claim 11 wherein the removable trim collar is removably received with the downlight opening on an external surface of the bottom wall.

13. The downlight fixture of claim 1 further comprising first and second telescoping and vertically adjustable hanger bar assemblies disposed on opposing sides of the housing.

14. A downlight fixture comprising:
a housing comprising,
a top wall,
opposing side walls,
opposing end walls,
a bottom wall with a downlight opening;
an interior dividing wall extending between the opposing side walls creating a larger main compartment at one end of the housing for receiving a lighting module and a smaller junction box compartment at the opposing second end of the housing,
said interior dividing wall having an access opening therein;
an access panel which is removably securable with the access opening from within the main compartment;
wherein the entirety of the housing is constructed from a material which provides a 2-hour fire rating and compliance with applicable building fire codes.

15. The downlight fixture of claim 14 further comprising a removable trim collar received with the downlight opening.

16. The downlight fixture of claim 14, further comprising:
a backup battery module comprising,
a battery module housing secured to the housing in place of one of the end walls;
a backup battery receivable within the battery module housing;
a battery wall access panel which is removably securable with the battery module housing from within the main compartment,
wherein the battery module housing and battery wall access panel are constructed from a material which provides a 2-hour fire rating and compliance with applicable building fire codes.

17. The downlight fixture of claim 15, further comprising:
a backup battery module comprising,
a battery module housing secured to the housing in place of one of the end walls;
a backup battery receivable within the battery module housing;
a battery wall access panel which is removably securable with the battery module housing from within the main compartment,
wherein the battery module housing and battery wall access panel are constructed from a material which provides a 2-hour fire rating and compliance with applicable building fire codes.

18. A downlight fixture comprising:
a housing comprising,
a top wall,
opposing side walls,
opposing end walls,
a bottom wall with a downlight opening;
an interior dividing wall extending between the opposing side walls creating a larger main compartment at one end of the housing for receiving a lighting module and a smaller junction box compartment at the opposing second end of the housing,
said interior dividing wall having an access opening therein;
an integrated wire conduit extending between the interior dividing wall and an end wall creating a dedicated wiring path from the junction box compartment to said end wall,
said wire conduit being constructed from a material which provides a 2-hour fire rating and compliance with applicable building fire codes.

19. The downlight fixture of claim 18 further comprising a removable trim collar received with the downlight opening.

20. The downlight fixture of claim 18, further comprising:
a backup battery module comprising,
a battery module housing secured to the housing in place of one of the end walls;
a backup battery receivable within the battery module housing;
a battery wall access panel which is removably securable with the battery module housing from within the main compartment,
wherein the battery module housing and battery wall access panel are constructed from a material which provides a 2-hour fire rating and compliance with applicable building fire codes.

21. The downlight fixture of claim 19, further comprising:
a backup battery module comprising,
a battery module housing secured to the housing in place of one of the end walls;
a backup battery receivable within the battery module housing;
a battery wall access panel which is removably securable with the battery module housing from within the main compartment,
wherein the battery module housing and battery wall access panel are constructed from a material which provides a 2-hour fire rating and compliance with applicable building fire codes.
